(19) United States
(12) Patent Application Publication
(10) Pub. No.: US 2026/0079684 A1
(43) Pub. Date: Mar. 19, 2026

(54) Application Programming Interface Discovery, Evaluation, and Publication

(71) Applicant: The Travelers Indemnity Company, Hartford, CT (US)

(72) Inventors: Joans Jesudoss Sahaya, South Windsor, CT (US); Ishan Dogra, Brampton (CA); Ahmed S. Noor, Roseville, MN (US)

(21) Appl. No.: 18/887,532

(22) Filed: Sep. 17, 2024

(51) Int. Cl. G06F 8/60; G06F 11/36

(52) U.S. Cl. CPC G06F 8/60; G06F 11/3604

(57) ABSTRACT

Techniques for detecting, evaluating, and publishing APIs are disclosed. A system monitors an API management service and, responsive to detecting the creation or modification of an API, generates a specification for the API. The system applies scanners to the specification that evaluate compliance with publication criteria. The system can select the scanners based on attributes extracted from the specification. Using the evaluation results, the system determines whether to publish the specification to an API repository.

### BACKGROUND

Application Programming Interfaces (APIs) are software interfaces that allow different computer applications and/or systems to communicate, interact, and share data. APIs enable integration and interoperability between software components of computing systems by defining methods and formats for exchanging information. For example, APIs provide standardized interfaces that expose functions and data of software components used to communicate with third-party platforms.

Entities, such as businesses and software developers, use APIs to share data with partners, customers, or third-party developers, while maintaining control over permissions and usage policies. By doing so, APIs enable businesses to create ecosystems that attract developers, partners, and third-party providers to build complementary services and applications.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example architecture of an API discovery, evaluation, and publication environment in accordance with one or more embodiments;

FIG. 2 illustrates an example architecture of an API management system in accordance with one or more embodiments;

FIG. 3 illustrates a functional block diagram of the example API management system in accordance with one or more embodiments;

FIG. 4 illustrates an example set of operations for discovering, evaluating, and publishing APIs in accordance with one or more embodiments; and

FIG. 5 illustrates an example embodiment of evaluating an API specification in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

### 1. General Overview

The disclosure is directed to techniques for managing API specifications and, more specifically, to an evaluation process for publishing API specifications to an API repository. In response to detecting the creation and modification of APIs, embodiments evaluate the conformance API specifications with publication criteria, generate notifications of the evaluation results, and publish the API specifications based on the evaluations.

One or more embodiments include systems and processes that monitor an API management service to detect creation and modification of APIs. Responsive to detecting the creation or modification of an API, a system generates a specification for the API. The system applies scanners to the specification that evaluate compliance with publication criteria. Some embodiments select particular scanners to apply using attributes extracted from the specification. Additionally, some embodiments, use trained machine learning models to intelligently select scanners appropriate for the particular specification. Based on the evaluation results output by the scanners, the system determines whether the specification satisfies publication criteria and publishes the specification to an API repository.

One or more embodiments described in this Specification and/or recited in the claims may not be included in this General Overview section.

### 2. Practical Applications, Advantages & Improvements

The disclosed techniques improve computing systems that manage and publish API specifications by detecting new or modified APIs and evaluating API specifications by applying different scanners tailored for particular contexts. As detailed herein, one or more embodiments detect new and modified APIs as the APIs are generated. Automatically identifying the new and modified APIs enables computing systems to evaluate and publish API specifications in real-time or near real-time. In a Software-as-a-Service (SaaS) cloud environment, embodiments detect and concurrently evaluate specifications of APIs generated by multiple users or tenants.

Additionally, one or more embodiments evaluate specifications generated for the APIs by selectively applying different sets of scanners tailored to publication criteria of different users, tenants, systems, and the like. These bespoke evaluations avoid verifying API specifications using inappropriate and/or redundant publication criteria. As a result, embodiments reduce the consumption of computational resources that would be consumed by performing preprocessing, evaluation, and presentation of irrelevant feedback based inappropriate and/or redundant publication criteria.

### 3. API Discovery, Evaluation, and Publication Environment Architecture

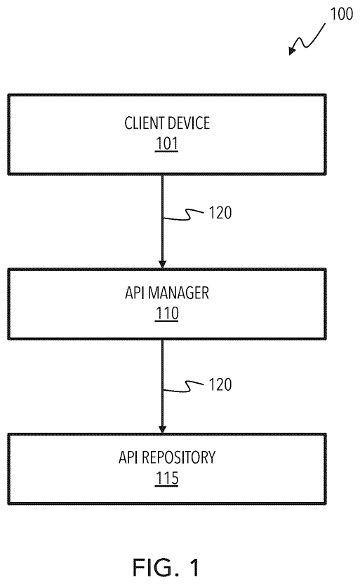

FIG. 1 shows a block diagram illustrating an example architecture of an environment 100 for implementing systems, methods, and computer program products in accordance with aspects of the present disclosure. The example environment 100 includes a client device 101, an API manager 110, and an API repository 115 in communication via one or more communication links 120. The components illustrated in FIG. 1 may be local to or remote from each other. Each component may be distributed over multiple applications and/or machines. Multiple components may be combined into one application and/or machine. Operations described with respect to one component may instead be performed by another component.

The client device 101 comprises a personal computing device, such as a desktop computer, a workstation, a remote terminal, a laptop computer, a tablet computer, a smartphone, or the like. In one or more embodiments, the client device 101 includes hardware and/or software configured to facilitate communications between a user and the client device 101 to create, modify, manage and configure APIs via the API manager 110. Users of the client device 101 may include, for example, software developers and/or engineers who create applications and services that interact with other software components or systems. In one or more embodiments, the user can be a member of a tenant, such as a corporation, organization, enterprise or other entity, which shares the API manager 110 with other tenants to access, create, modify, and publish APIs.

The communication links 120 can transmit data between the client device 101, the API manager 110, and the API repository 115. The communication links 120 can comprise any combination of wired and/or wireless links, any combination of one or more types of networks, including the Internet, an intranet, a wide-area network (WAN), a local-area network (LAN), a wireless network, a digital subscriber line (DSL) network, a frame relay network, an asynchronous transfer mode (ATM) network, and/or a virtual private network (VPN).

The API manager 110 comprises one or more computing systems that exchange information with the client device 101 and the API repository 115 to access, create, modify, and publish APIs. The API manager 110 may comprise any suitable server, processor, computer, data processing device, or combination of the same. As detailed below, the API manager 110 can provide tools for testing, deploying, and monitoring APIs and API specifications.

The API repository 115 comprises a storage system that maintains APIs, API definitions, and/or documentation. In some embodiments, the API repository may store, for example, API schemas, usage guidelines, and other metadata necessary for understanding and integrating the API to facilitate discovery and use of APIs. Version control systems integrated with the repository may allow for tracking changes and managing different API versions.

In a non-limiting example of environment 100, a user of the client device 101 modifies an API stored in the API repository 115 via the API manager 110. The user accesses the API manager 110 via a computer-user interface and selects a particular API to be modified. The user can then update various components of the API. For instance, to modify an endpoint in the API, the user defines a new resource path and associates the path with one or more HTTP methods. A component of API manager 110 monitors events indicating the creation and modification of any APIs, including the API modified by the user. In response to detecting the modified API, the API manager 110 generates a specification of the API and evaluates the specification to determine whether the API satisfies publication criteria. In some embodiments, the API manager 110 determines one or more scanners for evaluating the specification based on attributes extracted from the API's specification. Some embodiments intelligently select the scanners from a library of scanners using a trained machine learning model. The selected scanners can be configured to perform different evaluations of different aspects of the specification (e.g., authentication, data privacy, malware detection, cybersecurity) using different criteria. Based on the results of the evaluations, the API manager 110 determines whether the specification satisfies criteria for publication to the API repository 115. If no issues were identified, the API manager publishes the specification to the API repository. If not, the API manager 110 prevents publication and generates a report indicating the issues identified by the scanners that prevented publication.

While FIG. 1 illustrates a single client device 101, a single API manager 110, and a single API repository 115, it is understood that embodiments of the environment 100 consistent with the present disclosure can include multiple client devices 101, multiple API managers 110, and multiple API repositories 115 communicatively connected via multiple communication links 120 in various arrangements. Additionally, while the client device 101, API manager 110, and API repository 115 are described herein as providing certain features and functions, including computer-user interfaces, it is understood that some or all of the features and functions can, instead, be executed at the API manager 110 and provided to the client device 101 via the communication link 120 for provision to the user.

### 4. API Management System Architecture

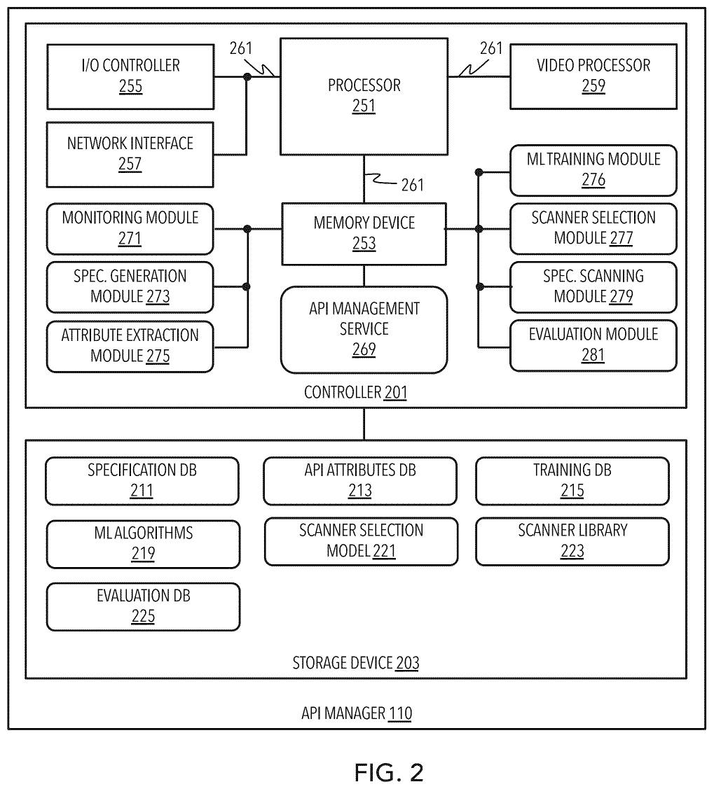

FIG. 2 illustrates a block diagram of an example system architecture of an API manager 110 in accordance with one or more embodiments. The API manager 110 includes hardware and software that perform processes and functions described herein. In one or more embodiments, the API manager 110 may include more or fewer components than the components illustrated in FIG. 2. The components illustrated in FIG. 2 may be local to or remote from each other. Each component may be distributed over multiple applications and/or machines. Multiple components may be combined into one application and/or machine. Operations described with respect to one component may instead be performed by another component.

The API manager 110 can include a controller 201 and one or more storage devices 203. In accordance with aspects of the present disclosure, the controller 201 and the storage device 203 are configured to perform specialized functions and operations, consistent with the embodiments described herein. Additionally, the API manager 110 can include one or more input/output (I/O) devices for interacting with a user. In some embodiments, users interact with the API manager 110 via I/O devices of a remote terminal (e.g., client device 101).

The storage device 203 can comprise a computer-readable, non-transitory storage device that stores information and program instructions executable by the controller 201. The storage device 203 includes any type of storage unit and/or device (e.g., a file system, database, collection of tables, or any other storage mechanism) for storing data. Additionally, the storage device 203 may include multiple different storage units and/or devices. The multiple different storage units and/or devices may or may not be of the same type or located at the same physical site. Furthermore, the storage device 203 may be implemented or executed on the same computing system as the API manager 110. Additionally, or alternatively, the storage device 203 may be implemented or executed on a computing system separate from the API manager 110. The storage device 203 may be communicatively coupled, wired and/or wirelessly, to the API manager 110 via a direct connection or via a network.

One or more embodiments of the storage device 203 stores an API specification database (“DB”) 211, an API attributes database 213, a training database 215, machine learning (“ML”) algorithms 219, a scanner selection model 221, a scanner library 223, and an evaluation database 225. The specification database (“DB”) 211 comprises one or more data structures storing API specifications. An API specification is a document that outlines the structure, behavior, and requirements of an API. API specifications can comprise computer-readable documents, such as JSON (“JavaScript Object Notation”) documents, defining endpoints, the HTTP methods supported by individual endpoints, and expected input and output formats. Additionally, API specifications can define parameters, headers, request bodies, status codes, and/or error messages. Also, the specifications can define interface and interoperability requirements. Further, API specifications may define security requirements, such as authentication, authorization, cyber-protection, malware, and privacy requirements. Example, formats for API specifications may include OpenAPI Specification (“OpenAPI”), RESTful API Modeling Language (“RAML”), and API Blueprint.

The API attributes database 213 comprises one or more data structures storing attributes describing API specifications. The attributes include parameters and keywords defining the API's functions, usage, context, and requirements. For example, the attributes may include the endpoints, methods, parameters, request and response formats, status codes, error handling procedures, and/or security requirements. The attributes can also include metadata, such as version, title, description, terms of service, contact information for support, licensing details, and/or usage limits or quotas. The attributes may also describe the authentication and authorization mechanisms for accessing APIs, such as keys and tokens. The attributes can also include context information, such as use and distribution restrictions (internal, external, internet), access restrictions (e.g., authentication requirements), security restrictions (e.g., confidential, secret, etc.), and/or privacy restrictions (e.g., personally identifying information, medical records).

The training database 215 comprises one or more data structures storing sets of training data for training the scanner selection model 221. The training data sets can include attributes corresponding to API specifications. Additionally, the training data sets include labels indicating appropriate sets of scanners for scanning respective API specifications.

The machine learning algorithms 219 comprise one or more algorithms that are iterated to train machine learning models to map a set of input variables to an output variable. In particular, the machine learning algorithms are configured to train one or more scanner selection models 221 to map attributes of API specifications to sets of scanners for evaluating the specifications. A machine learning algorithm generates a target model such that the target model best fits the datasets of training data to the labels of the training data. Additionally, or alternatively, a machine learning algorithm generates a target model such that when the target model is applied to the sets of the training data, a maximum number of results determined by the target model matches the labels of sets of the training data. Different target models can be generated based on different machine learning algorithms and/or different sets of training data. The algorithms include supervised components and/or unsupervised components. Algorithms, such as linear regression, logistic regression, linear discriminant analysis, classification and regression trees, naïve Bayes, k-nearest neighbors, learning vector quantization, support vector machine, bagging and random forest, boosting, backpropagation, and/or clustering can be used.

The scanner selection model 221 comprises one or more algorithms or machine learning models that determine sets of scanners to be applied to particular API specifications based on attributes of the individual specifications. In some embodiments, the scanner selection model 221 is a clustering machine learning model trained to determine a cluster for a target API specification and select a set of corresponding scanners. In some other embodiments, the scanner selection model 221 comprises a supervised machine learning model trained to determine a set of scanners based on attributes of a target API specification.

The scanner library 223 comprises a collection of scanners for evaluating API specifications. The scanners comprise software tools configured to scan APIs and verify that API specifications satisfy publication criteria. The scanner library 223 can include commercially available (“COTS”) scanning platforms, targeted scanners, and/or application-specific scanners. An example of a COTS API scanning platform is 42CRUNCH sold by 42CRUNCH LTD, which includes an integrated set of tools that test security, malware and cyber vulnerability, interoperability, formatting, and privacy. Modular scanning tools perform particular evaluation tasks using particular evaluation criteria. Examples of targeted scanners include: a security scanner, a malware and cyber vulnerability scanner, an interoperability scanner, a formatting scanner, and a privacy scanner. The scanner library 223 can include multiple scanners that have the same function but different scopes and/or different criteria. For example, a first targeted scanner can be configured for low-risk internal contexts and a second targeted scanner can be configured for a high-risk external context. Application-specific scanners include scanning tools configured for particular environments or particular clients. For example, a scanner of one client can define a specific set of allowed endpoints and disallowed endpoints. A scanner of another client can define specific access and privacy requirements.

The evaluation database 225 comprises one or more data structures storing sets of evaluation data determined by the scanners applied to API specifications. The evaluation data includes, for some or all the scanners applied to a specification, an evaluation result and evaluation information. The evaluation results indicate whether a specification passed a corresponding evaluation and to what degree. For example, the evaluation result can comprise a pass/failure parameter (e.g., 0 or 1) indicating a binary result of the evaluation. Additionally, or alternatively, the evaluation result can comprise a score (e.g., 80/100) indicating the portion (e.g., rank or a percentage) of the evaluation for which the specification passed. In some embodiments, a minimum score (e.g., 90) for each scanner is necessary for an individual specification to pass the evaluation and be published. The evaluation information describes the errors or issues identified by the scanners. For example, a security scanner can output evaluation information describing missing authentication mechanisms, insufficient data validation, and/or exposure to common threats. A compliance scanner can output evaluation information, such as structural correctness, adherence to naming conventions, completeness of the documentation, improper parameter naming, and/or non-standard response codes (e.g., syntactical correctness).

Still referring to FIG. 2, the controller 201 may include one or more processors 251, one or more memory devices 253, one or more input/output (I/O) controllers 255, one or more network interfaces 257, and one or more image (e.g., video) processors 259. Additionally, the controller 201 may include at least one communication channel 261 (e.g., a data bus) by which the processor 251 communicates with the one or more memory devices 253, the one or more input/output (I/O) controllers 255, the one or more network interfaces 257, and/or the one or more image processors 259.

The processor 251 executes computer program instructions which may be stored in the memory device 253 and/or the storage device 203. The processor 251 can comprise one or more general-purpose processors, special-purpose processors, or other programmable data processing apparatuses providing the functionality and operations detailed herein.

The memory device 253 comprises a local memory employed during execution of program instructions. In some embodiments, the memory device 253 can include random access memory (RAMs) units, read only memory (ROMs), flash memory (e.g., solid state drives (SSDs)), electrically erasable/programmable read only memory (EEPROMs), etc. It should be appreciated that in some embodiments, communication between the memory device 253, the storage device 203, and the processor 251, encompasses the processor 251 accessing the memory device 253 and/or the storage device 203, exchanging data with the memory device 253 and/or the storage device 203 (e.g., reading/writing data to the memory device 253), or storing data to the memory device 253 and/or the storage device 203.

The network interface 257 includes a digital device that provide network communications with external devices (e.g., client device 101 and API repository 115). For example, the network interface 257 can connect the API manager 110 to a local area network (LAN), a wide area network (WAN), and/or the Internet. The network interface 257 may include wired and/or wireless communication hardware.

The video processor 259 communicates with the processor 251 to generate and render at least some of the graphics, displays, and information displayed by the API manager 110. In some embodiments, the video processor 259 includes one or more data processors, controllers, and/or graphics cards for processing the user interface images and coordinating the processed data to be displayed between, among, or across any or all display devices.

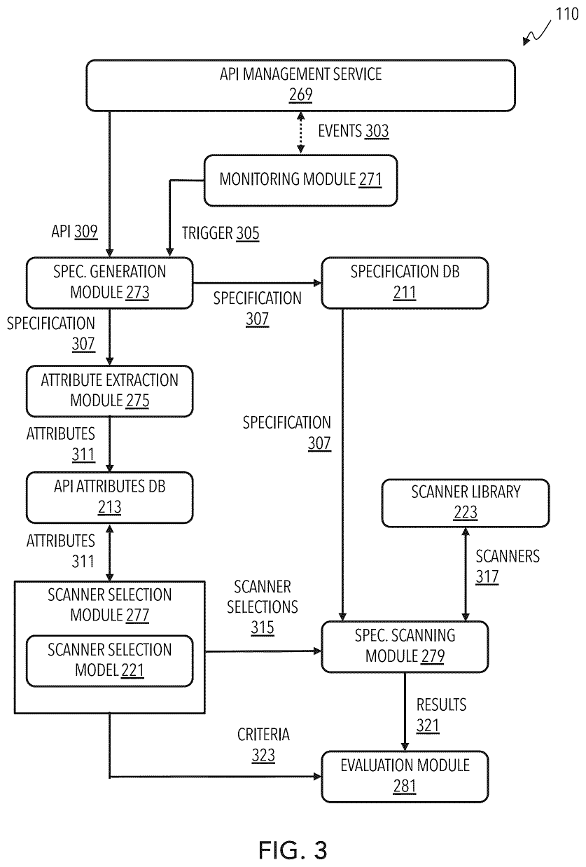

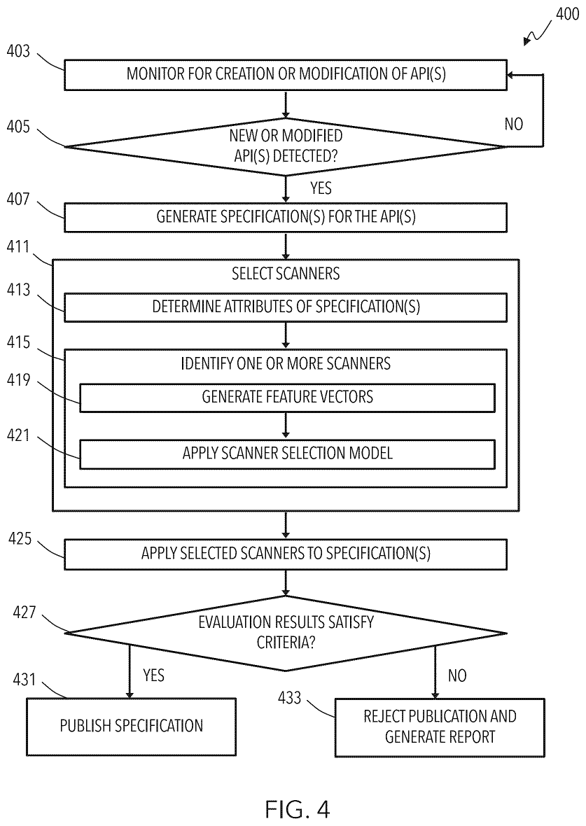

The controller 201 includes hardware and/or software configured to perform operations described herein. Example operations are described below with reference to FIGS. 3 and 4. The controller 201 executes computer-readable program instructions, such as an operating system and application programs, stored in the memory device 253 and/or the storage system 203. Moreover, the controller 201 executes program instructions of an API management service 269, a monitoring module 271, a specification generation module 273, an attribute extraction module 275, machine learning training module 276, a scanner selection module 277, a specification scanning module 279, and/or an evaluation module 281.

As detailed below, the API management service 269 creates, publishes, maintains, monitors, and/or secures APIs. The monitoring module 271 detects new and modified APIs generated by clients (e.g., client device 101). The specification generation module 273 generates specifications based on the content of APIs. The attribute extraction module 275 determines attributes from API specifications. The machine learning training module 276 executes machine learning algorithms to train the scanner selection model 221. The scanner selection module 277 determines scanners to be applied to individual API specifications. The specification scanning module 279 scans the specification using the scanners output by the scanner selection module 277 and obtained from scanner library 223. The evaluation module 281 evaluates the results of the scans, generates results, reports scanning issues, and/or publishes the specifications.

In one or more embodiments, the training module 276 uses the machine learning algorithms 219 to train the scanner selection model 221. The scanner selection model 221 can be trained using attributes of specifications in the training database 215, as well as weights or other labels of scanners applied to the specifications. Some embodiments of the training module 276 train a clustering-type machine learning model to select scanners to apply to a particular specification.

Using attributes of a set of API specifications, the training module 276 computes and stores feature vectors. The attributes of a particular feature vector can include keywords extracted from a particular specification. Using transformation techniques, the system can combine some or the entire set of attributes into feature vectors for corresponding specifications.

The training module 276 may train a clustering-type machine learning model for grouping specifications into clusters. Training a clustering-type machine learning model includes grouping the specifications into clusters based on patterns or similarities within the attributes of the individual specifications. The clustering-type machine learning model may be trained using a clustering algorithm, such as K-Means, Hierarchical Clustering, DBSCAN, and/or Gaussian Mixture Models (GMM). The training module 276 trains the selected model by inputting the feature vectors into the selected algorithm. Training the model includes applying individual feature vectors to the selected clustering algorithm to partition the data points into distinct groups or clusters based on their similarities. The algorithm evaluates the distance between feature vectors, aiming to maximize intra-cluster similarity while minimizing inter-cluster similarity. The distance metric may be calculated using, for example, a Euclidean distance, Manhattan distance, and/or cosine similarity, among others, to quantify the dissimilarity between feature vectors and clusters by measuring the geometric or algebraic separation between them within the feature space. The model adjusts the algorithm's parameters and iteratively refines the model. The algorithm groups similar data points together to train the model by teaching the algorithm to determine clusters based on the feature vectors. The algorithms partition the data into subsets, or clusters, where the data points within a cluster are more similar to each other than to instances in other clusters. This iterative process continues until a convergence criterion is met, indicating stability in the clustering assignments. The final output of the clustering algorithm is a set of clusters containing data points that are considered similar based on the features in their respective feature vectors.

Some embodiments of the training module 276 train a supervised machine learning model to select the scanners. Using the attributes of specifications in the training database 215, the training module 276 determines feature vectors representing the attributes. Individual elements of the vector represent a specific attribute or feature. Additionally, the training data sets can also include labels indicating an appropriate set of scanners for the individual vectors. An individual, such as a subject matter expert, can assign the labels. The training module 276 trains the machine learning model to compute a set of scanners by applying the training dataset to a supervised learning algorithm. The algorithm may comprise, for example, a linear regression algorithm or a random forest algorithm. By inputting the document features and the corresponding tool labels, the model iteratively learns to map specification attributes to the appropriate set of error scanning tools.

### 5. API Management System Functional Architecture

FIG. 3 illustrates a functional block diagram of the example API manager 110 in accordance with one or more embodiments. The API manager 110 includes API management service 269, monitoring module 271, specification generation module 273, attribute extraction module 275, scanner selection module 277, specification scanning module 279, and evaluation module 281, each of which can be the same or similar to those previously describe above. The components illustrated in FIG. 3 may be local to or remote from each other. Each component may be distributed over multiple applications and/or machines. Multiple components may be combined into one application and/or machine. Operations described with respect to one component may instead be performed by another component.

A user (via, e.g., client device 101) can create or modify an API using the API management service 269. The user can, for example, control the API management service 269 to retrieve an existing API from storage (e.g., API repository 115) to modify the API's performance, functionality, compatibly, and/or security. Via a user-interface of the API management service 269, the user can define endpoints, request and response formats, authentication methods, and/or other aspects to generate a modified API 309.

The monitoring module 271 detects the modified API 309 generated using the API management service 269 by receiving information indicative of one or more of API creation and modification. Some embodiments of the monitoring module 271 detect the creation and modification of the API 309 by subscribing to publications of events 303 by the API management service 269. Some embodiments of the monitoring module 271 detect the modification of the API 309 by executing a daemon that periodically queries API management service 269 to detect events 303 by comparing the current states of the APIs with the previous states. Some embodiments of the monitoring module 271 use tools of the API management service 269, such as AMAZON WEB SERVICES (“AWS”)® CLOUDWATCH EVENTS or AWS EVENTBRIDGE to listen for specific events or combinations of events 303 of the API management service 269. Example events 303 include commands to create a new API, retrieve an existing API, store an API, update a version indicator of an API, and rename an API.

Responsive to detecting the modified API 309, the monitoring module 271 generates a trigger 305 that causes the specification generation module 273 to generate a specification 307 for the API 309. The specification generation module 273 obtains the modified API 309 from the API management service 269, as illustrated in FIG. 3, or retrieves the API from storage (e.g., API repository 115).

The specification generation module 273 can generate the specification 307 using a predefined schema, such as OpenAPI, and stores the specification 307 in the specification database 211. As previously described, the specification 307 defines endpoints, request formats, input parameters, and response formats. Some embodiments of the specification generation module 273 determine the contents of the specification by analyzing the underlying data structures and operations of the application or service the API 309 exposes. Some embodiments of the specification generation module 273 inspect the application's database schema, codebase, or metadata to identify the entities and their relationships. For instance, by examining a database table called “Users,” the specification generation module 273 can infer the user identifiers and endpoints. Additionally, some embodiments of specification generation module 273 determine request methods based on types of operations performed on the entities, such as inferring GET for data retrieval, POST for creating new records, PUT or PATCH for updates, and DELETE for removal. Further, some embodiments of the specification generation module 273 determine input parameters from the fields of the entities, where each column in a “Users” table (like ‘name’, ‘email’, ‘age’) becomes a parameter in the API requests. Moreover, some embodiments of the specification generation module 273 determine response formats based on the expected output structure of operations, typically mirroring the entity's fields. Additionally, or alternatively, some embodiments receive user inputs or apply machine learning techniques to obtain and/or refine the determined endpoints, request methods, input parameters, and/or response formats based on code comments and/or documentation.

The attribute extraction module 275 extracts attributes of the API 309 from the specification 307. The attribute extraction module 275 stores the extracted attributes 311 in the API attributes database 213. Determining attributes can include parsing the specification 307 and identifying elements that describe the API's functionality, resources, and operations, such as parameters, schemas, titles, summaries, and descriptions. Some embodiments of the attribute extraction module 275 use Natural Language Processing (NLP) techniques to extract the attributes. For example, the software can use tokenization to identify individual words or phrases, and then apply part-of-speech tagging to identify nouns and noun phrases that are likely to be relevant keywords. By doing so, the attribute extraction module 275 can identify attributes indicative of the API's 309 context (e.g., internal, external, public), functions (e.g., authentication, data retrieval, data submission, resource update, integration), and security requirements (e.g., public, confidential, secret).

The scanner selection module 277 determines a set of one or more scanner selections 315 for evaluating/validating the specification 307. Some embodiments of the scanner selection module 277 select scanners based on predefined mappings. For instance, the scanner library 223 can store predefined mappings of one or more scanners for particular clients and users. Additionally, or alternatively, some embodiments of the scanner selection module 277 apply the scanner selection model 221 to select scanners based on the attributes 311 extracted from the specification. As described above, some embodiments of the scanner selection module 277 apply a trained machine learning scanner selection model 221 to determine scanner selections 315 for the specification 307.

The specification scanning module 279 retrieves from scanner library 223 the scanners 317 identified by scanner selections 315 output by the scanner selection module 277. The specification scanning module 279 then applies the scanners 317 to the specification 307 and generates results 321. Each of the scanners 317 can output a result 321 indicating whether the specification 307 passed a corresponding evaluation. For example, the evaluation result can comprise a pass/failure (e.g., 0 or 1) parameter indicating a binary result of the evaluation. Additionally, or alternatively, the evaluation result can comprise a score (e.g., 80/100) indicating the portion (e.g., rank or a percentage) of the evaluation for which the specification passed.

The evaluation module 281 evaluates the results of the scans, generates results, and publishes the specifications. In some embodiments, the specification must pass evaluation in order to be published. In some embodiments, the evaluation module 281 applies a predefined threshold to the results of all the scanners. For example, the score of each scanner must be at least 90/100. In other embodiments, each scanner is associated with a respective threshold criteria 323. For example, a criteria stored with a first scanner may require 90/100 to pass evaluation, a criteria stored with a second scanner may require 75/100 to pass evaluation, and a criteria stored with a third scanner may require “pass”of a pass/fail score to pass evaluation.

While the example described above and illustrated in FIG. 3 describes the evaluation of a single API by a single user, it is understood that embodiments of the API manager service 269 accept and process many concurrent API evaluations by many users. For example, the API manager service 269 can be implemented in a SaaS cloud environment in which multiple processors execute multiple threads concurrently by processing many (e.g., hundreds or thousands) evaluations in parallel.

### 6. API Specification Evaluation and Publication Process

FIG. 4 is a process flow block diagram illustrating an example process 400 for detecting, evaluating, and publishing API specifications in accordance with one or more embodiments. At block 403, a system (e.g., API manager 110) monitors an API management service (e.g., API management service 269) to detect the creation or modification of APIs. The system can execute monitoring software (e.g., monitoring module 271) that detects one or more events indicating the creation or modification of an API. Some embodiments detect events published by the API management service by periodically comparing the current states of the APIs with the previous states, and/or by listening for events indicating a new or modified API. As noted above, some embodiments operate in a multi-client and/or multi-tenant environment in which multiple users can modify concurrently or within the same monitoring period. For example, the API manager service 269 can be implemented in a SaaS cloud environment in which multiple processors execute multiple threads concurrently by processing many (e.g., tens, hundreds or thousands) evaluations in parallel. By continuously monitoring the API management service, one or more embodiments detect the creation or modification of APIs by multiple users in real-time or near real-time to minimize the time and energy involved in API evaluation.

At block 405, the system determines whether new or modified APIs were detected based on the monitoring at block 403. If not, the process 400 returns to block 403 and the system continues to monitor for the creation or modification of APIs. On the other hand, in response to detecting one or more new or modified APIs, the process 400 proceeds to block 407. At block 407, the system (e.g., executing specification generation module 273) generates specifications for the new or modified API detected at block 405. As previously described, the specification defines the structure, behavior, and requirements of an API, such as endpoints, HTTP methods supported by individual endpoints, expected input and output formats, parameters, headers, request bodies, status codes, error messages, security requirements, and authorization requirements. For example, based on the API's structure, the system uses information from the API to populate a document schema, such as OpenAPI. Additionally, the system can identify specific paths associated with each endpoint, authentication requirements, and security parameters.

At block 411, the system (e.g., executing scanner selection module 277) selects one or more scanners for evaluating the APIs detected at block 405 based on the attributes extracted from the specification generated at block 407. Selecting the scanners includes, at block 413, determining the attributes of a specification by parsing the document and identifying elements that describe the API's category and type. As detailed above, attributes can include endpoints, input and output formats, parameters, headers, request bodies, status codes, error message, security requirements, and authorization requirements.

Additionally, the system can infer attributes based on the content of a specification. Inferred attributes can include categories, types, target systems, and security levels of APIs. Example categories can include financial, medical, security, and the like. Example types of APIs can include Web APIs, library APIs, operating system APIs, database APIs, remote APIs, and hardware APIs. Target systems can indicate specific systems, applications, or clients. Security levels can include low, medium, high, and maximum security. Some embodiments also infer attributes from descriptions and endpoints in a specification. The system can infer the attributes using, for example, keyword matching, regular expression, Term Frequency-Inverse Document Frequency (TF-IDF), and machine learning techniques. For example, based on keywords in the specification and endpoints, the system can identify target industries or applications included in the API's description. Additionally, keywords in the endpoints can indicate financial transactions, retrieve stock market data, or manage bank accounts, which are used by financial services. In another example, keywords for medical services can be indicated by an endpoint related to patient record management, appointment scheduling, and telehealth. Further, the system can infer the level of security from keywords related to authentication mechanisms, and data privacy that reflect the requirements.

Selecting the scanners also includes, at block 415, identifying one or more scanners. The system can store a library of scanners (e.g., scanner library 223) from which the system chooses based on the attributes determined at 413. For example, the library can include COTS scanners, such as 42CRUNCH, which perform a variety of scans. Additionally, the library can include targeted scanners based on the specification's attributes, including category, type, target user, security level, or other attributes. For example, the scanners have targeted scopes, including authentication, data protection, governance, security, interoperability, usability, scalability, and performance. Further, the library can include user-specific and client-specific scanners for evaluating specifications using a particular user's or client's requirements. The individual scanners can have corresponding evaluation criteria. By identifying particular scanners based on respective attributes of a particular specification, embodiments avoid consuming processing time and energy to verify that the specifications satisfy irrelevant and redundant evaluation criteria.

Some embodiments identify the scanners using a trained machine learning model (e.g., scanner selection model 221) trained to classify the API specification into one of a number of predefined classes having attributes similar to the specification generated at block 407. Identifying the scanners can include, at block 419, generating feature vectors using the attributes determined at block 413. Identifying the scanners also includes, at block 421, applying a machine learning model (e.g., scanner selection model 221) to the feature vectors. One or more embodiments determine scanners using a clustering-type machine learning model by calculating a feature vector representing attributes of the specification. The system applies the machine learning model to the feature vector that clusters the target feature vector in the same cluster as a particular feature vector representing a particular specification. Responsive to determining that the target feature vector is in the same cluster as the particular feature vector, the system selects scanners corresponding to the specification. Alternatively, some embodiments identify the scanners using a supervised machine learning model. The system generates a feature vector representing the specification. Using the machine learning model, the system determines a set of one or more scanners for the specification. Alternatively, some embodiments identify the scanners using a rule-based selection. The rule-based selection can apply criteria that map attributes or sets of attributes to particular scanners. Additionally, the criteria can exclude particular scanners for selection based on attributes or sets of attributes. For example, based on attributes identifying a medical provider, the provider's business segment, and endpoints that access patient medical records, the system can identify a set of scanners appropriate for medical database systems, while excluding scanners appropriate for investment trading platforms.

At block 425, the system applies the one or more scanners selected at block 411 to the specifications generated at block 407. The individual scanners can have particular scopes corresponding to particular specifications. Accordingly, for two different specifications, the system can apply a first set of scanners to the first specification and apply a second set of scanners to the second specification, wherein at least one scanner of the first set of scanners is different than the second set of scanners. For example, the first set of scanners can include a particular scanner with higher security criteria than the second set of scanners. The individual scanners applied at block 425 output results indicating whether the specification passed a respective evaluation. As detailed above, the evaluation result can be a pass/failure (e.g., 0 or 1) parameter indicating a binary result of the evaluation. Additionally, or alternatively, the evaluation result can be a score (e.g., 80/100) indicating the portion (e.g., rank or a percentage) of the evaluation for which the specification passed.

At block 427, the system determines if the results of the evaluations by the scanners satisfy the criteria of the scanners. The results can be assessed individually. For example, if any scan result fails to meet a respective criteria, then the corresponding specification fails. Alternatively, evaluation results can be assessed in combination. For example, the system can determine an average score or a weighted average score that gives greater importance to some scanner results (e.g., security) than others (e.g., formatting). Accordingly, different specifications can be determined to have a different evaluation score based on different criteria. If a specification passes the evaluation (e.g., block 427 is “Yes”), at block 431, the system publishes the specification. If not (e.g., block 427 is “No”), at block 433, the system rejects publication of the specification and generates a report indicating the evaluation score and evaluation information. Generating the report can include transmitting a notification to the user that modified or created the corresponding API. The evaluation information describes the errors or issues identified by the individual scanners. For example, a security scanner can output evaluation information describing missing authentication mechanisms, insufficient data validation, and exposure to common threats. Additionally, a compliance scanner can output evaluation information, such as structural correctness, adherence to naming conventions, the completeness of the documentation, improper parameter naming, non-standard response codes, and syntactical correctness. Further, the evaluation data can include actionable feedback that helps developers improve the robustness, security, and quality of their API specifications. The system can store the scores, evaluation information, and feedback for generating an interactive report.

### 7. Example Embodiment

An example is described below for purposes of clarity. Components and/or operations described below should be understood as one specific example which may not be applicable to certain embodiments. Accordingly, components and/or operations described below should not be construed as limiting the scope of any of the claims.

In accordance with the forgoing description, a user may wish to update an existing API with new functionality. The user can access the API manager 110 to modify the existing API. The user can obtain the existing API by searching and retrieving the API from a catalog via a user-interface generated by the API manager 110. The API can be stored in an API management tool, such as MULESOFT®, and found by querying the catalog based on the API's name and/or list of functions. Via the API manager 110, the user can modify the retrieved API by adding new functions and storing the modified API.

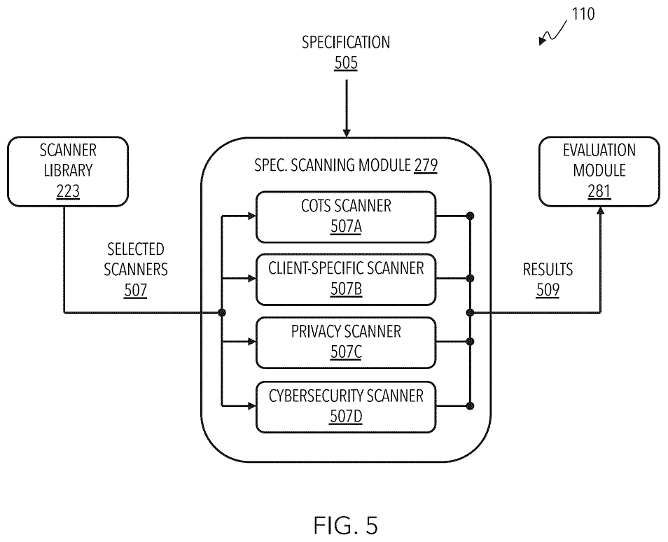

As detailed above, the API manager 110 monitors events indicating creation or modification of APIs. As illustrated in FIG. 5, responsive to detecting the user's modification of the API, the API manager 110 generates a specification 505, scans the specification 505 using a selection of scanners 507, and generates results 509 of the scans for publishing the specification 505. More specifically, the API manager 110 includes a scanner library 223, a specification scanning module 279, and an evaluation module 281, which can each be the same as those previously described. The selected scanners 507 evaluate different aspects of the specification 505 based on particular attributes of the specification 505. For instance, the attributes may indicate target environments, target security restrictions, and target users of the modified API described by the specification 505.

In the present example, the specification 505 relates to an API used by a health insurance provider. The specification 505 includes attributes identifying, among other things, the provider, the provider's business segment, and endpoints that access patient medical records. Based on the attributes of the specification 505, the API manager 110 identifies the selected scanners 507 to be applied by the specification scanning module 279. For example, the API manager 110 can intelligently identify the selected scanners 507 using rule-based or machine learning techniques. The selected scanners 507 include a COTS scanner 507A, a client-specific scanner 507B, a privacy scanner 507C, and a cybersecurity scanner 507D. The COTS scanner 507A comprises an integrated scanning suite, such as 42CRUNCH, obtained from a third party provider. In some embodiments, the COTS scanner 507A is a default scanner included in all evaluations. The client-specific scanner 507B comprises a target scanner required by a particular client to ensure interoperability with a legacy medical records system. The privacy scanner 507C comprises a target scanner selected based on attributes indicating access to personal medication access requiring authorization criteria that are greater than those evaluated by the COTS scanner 507A to comply with regulations for protecting personal health information. The cybersecurity scanner 507D comprises a targeted scanner selected by the system based on attributes indicating a medical system having heightened access and authorization criteria.

The evaluation module 281 evaluates the results 509 of the selected scanners 507 and determines whether the specification 505 passed the evaluations. For example, the evaluation module 281 determines whether each evaluation result satisfies a corresponding criteria. If so, the evaluation module 281 writes the specification 505 to an API catalog. If not, the evaluation module 281 can generate notifications indicating scan results and metadata. The notifications can be sent via a messaging system (e.g., SMS). For example, notification can identify the issue and allow the user to address the issue. The message may include a hyperlink to the report. After the user corrects the errors by updating the API, the API manager 110 repeats the process. The iterations of detecting, scanning, and evaluating can continue until the specification 505 passes all the evaluations by the selected scanners 507 and is published by the API manager 110 to an API repository.

### 8. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A system comprising a computing device comprising a processor and a computer-readable storage device storing program instructions that, when executed by the processor, cause the computing device to perform operations comprising:
monitoring an Application Programming Interface (API) management service to detect creation and modification of APIs;
detecting the creation or modification of a plurality of APIs;
responsive to the detecting, generating a plurality of specifications corresponding to the plurality of APIs;
applying a plurality of scanners to the plurality of specifications, wherein individual scanners of the plurality of scanners evaluate compliance with respective evaluation criteria of the individual scanners;
based on the respective evaluations of the plurality of specifications:
determining that one or more specifications of the plurality of specifications satisfy the respective evaluation criteria; and
publishing the one or more of the plurality of specifications to an API repository.

2. The system of claim 1, wherein detecting the creation or modification of a plurality of APIs comprises receiving information indicative of one or more of API creation and modification.

3. The system of claim 2, wherein the information indicative of one or more of API creation and modification comprises at least one of a publication of an event of a subscription service, a daemon query result, and a listening service output.

4. The system of claim 1, wherein applying one or more scanners comprises:
applying a first set of scanners of the plurality of scanners to a first specification of the plurality of specifications; and
applying a second set of scanners of the plurality of scanners to a second specification of the plurality of specifications, wherein the first set of scanners is different than the second set of scanners.

5. The system of claim 4, wherein applying one or more scanners comprises generating a plurality of evaluation scores, the plurality of evaluation scores including:
a first set of evaluation scores computed by the first set of scanners; and
a second set evaluation scores computed by the second set of scanners.

6. The system of claim 4, wherein the operations further comprise:
identifying the first set of scanners by applying a trained machine learning model to a first set of attributes of the first specification; and
identifying the second set of scanners by applying the trained machine learning model to a second set of attributes of the second specification.

7. The system of claim 1, wherein the evaluation criteria comprise at least one of authentication criteria, data protection criteria, governance criteria, security criteria, interoperability criteria, usability criteria, scalability criteria, and performance criteria.

8. The system of claim 1, wherein publishing the one or more of the plurality of specifications comprises:
in response to determining that a first specification of the plurality of specifications satisfies the respective evaluation criteria, publishing the first specification; and
in response to determining that a second specification of the plurality of specifications fails to satisfy the respective evaluation criteria, rejecting publication of the second specification.

9. A non-transitory computer readable medium comprising instructions which, when executed by one or more hardware processors, causes performance of operations comprising:
monitoring an Application Programming Interface (API) management service to detect creation and modification of APIs;
detecting the creation or modification of a plurality of APIs;
responsive to the detecting, generating a plurality of specifications corresponding to the plurality of APIs;
applying a plurality of scanners to the plurality of specifications, wherein individual scanners of the plurality of scanners evaluate compliance with respective evaluation criteria of the individual scanners;
based on the respective evaluations of the plurality of specifications:
determining that one or more specifications of the plurality of specifications satisfy the respective evaluation criteria; and
publishing the one or more of the plurality of specifications to an API repository.

10. The non-transitory computer readable medium of claim 9, wherein detecting the creation or modification of a plurality of APIs comprises receiving information indicative of one or more of API creation and modification.

11. The non-transitory computer readable medium claim 10, wherein the information indicative of one or more of API creation and modification comprises at least one of a publication of an event of a subscription service, a daemon query result, and a listening service output.

12. The non-transitory computer readable medium of claim 9, wherein applying one or more scanners comprises:
applying a first set of scanners of the plurality of scanners to a first specification of the plurality of specifications; and
applying a second set of plurality of scanners to a second specification of the plurality of specifications,
wherein the first set of scanners is different than the second set of scanners.

13. The non-transitory computer readable medium of claim 12, wherein applying one or more scanners comprises generating a plurality of evaluation scores, the plurality of evaluation scores including:
a first set of evaluation scores computed by the first set of scanners; and
a second set evaluation scores computed by the second set of scanners.

14. The non-transitory computer readable medium of claim 12, wherein the operations further comprise:
identifying the first set of scanners by applying a trained machine learning model to a first set of attributes of the first specification; and
identifying the second set of scanners by applying the trained machine learning model to a second set of attributes of the second specification.

15. The non-transitory computer readable medium of claim 9, wherein the evaluation criteria comprise at least one of: authentication criteria, data protection criteria, governance criteria, security criteria, interoperability criteria; usability criteria, scalability criteria, and performance criteria.

16. The non-transitory computer readable medium of claim 9, wherein publishing the one or more of the plurality of specifications comprises:
in response to determining that a first specification of the plurality of specifications satisfies the respective evaluation criteria, publishing the first specification; and
in response to determining that a second specification of the plurality of specifications fails to satisfy the respective evaluation criteria, rejecting publication of the second specification.

17. A method comprising:
monitoring an Application Programming Interface (API) management service to detect creation and modification of APIs;
detecting the creation or modification of a plurality of APIs;
responsive to the detecting, generating a plurality of specifications corresponding to the plurality of APIs;
applying a plurality of scanners to the plurality of specifications, wherein individual scanners of the plurality of scanners evaluate compliance with respective evaluation criteria of the individual scanners;
based on the respective evaluations of the plurality of specifications:
determining that one or more specifications of the plurality of specifications satisfy the respective evaluation criteria; and
publishing the one or more of the plurality of specifications to an API repository.

18. The method of claim 17, wherein detecting the creation or modification of a plurality of APIs comprises receiving information indicative of one or more of API creation and modification.

19. The method of claim 18, wherein the information indicative of one or more of API creation and modification comprises at least one of a publication of an event of a subscription service, a daemon query result, and a listening service output.

20. The method of claim 17, wherein applying one or more scanners comprises:
applying a first set of scanners of the plurality of scanners to a first specification of the plurality of specifications; and
applying a second set of plurality of scanners to a second specification of the plurality of specifications,
wherein the first set of scanners is different than the second set of scanners.

21. The method of claim 20, wherein applying the one or more scanners comprises generating a plurality of evaluation scores, the plurality of evaluation scores including:
a first set of evaluation scores computed by the first set of scanners; and
a second set evaluation scores computed by the second set of scanners.

22. The method of claim 20, further comprising:
identifying the first set of scanners by applying a trained machine learning model to a first set of attributes of the first specification; and
identifying the second set of scanners by applying the trained machine learning model to a second set of attributes of the second specification.

23. The method of claim 17, wherein the evaluation criteria comprise at least one of:
authentication criteria, data protection criteria, governance criteria, security criteria, interoperability criteria; usability criteria, scalability criteria, and performance criteria.

24. The method of claim 17, wherein publishing the one or more of the plurality of specifications comprises:
in response to determining that a first specification of the plurality of specifications satisfies the respective evaluation criteria, publishing the first specification; and
in response to determining that a second specification of the plurality of specifications fails to satisfy the respective evaluation criteria, rejecting publication of the second specification.
